(19) United States
(12) Patent Application Publication
(10) Pub. No.: US 2013/0054617 A1
(43) Pub. Date: Feb. 28, 2013

(54) Linking Browser Content to Social Network Data

(71) Applicant: Alison Williams Colman, Portland, OR (US)

(72) Inventor: Alison Williams Colman, Portland, OR (US)

(21) Appl. No.: 13/598,730

(22) Filed: Aug. 30, 2012

Related U.S. Application Data
(60) Provisional application No. 61/529,053, filed on Aug. 30, 2011.

(51) Int. Cl. G06F 17/30

(52) U.S. Cl. 707/748; 707/E17.005

(57) ABSTRACT

Abstract Social networks contain a wealth of personal data when a user is accepted as a trusted contact by a second user. This data can be used to mine server accessed internet content to highlight information related to a user's trusted contacts. Here an application extracts information from server accessed content, correlates it to information taken from social networking and alerts the user to information in the content related to their trusted contacts.

### PRIORITY

This application claims priority to provisional application 61/529053 filed on Aug. 30, 2011 titled “Linking Browser Content to Social Network Data” and is incorporated herein by reference in its entirety.

### SUMMARY

This disclosure relates to downloaded or internet sourced content and social network data. Social networks allow the user to enter data and upload content related to a user's personal life or to a user's enterprise and this data and content may be displayed to others. On the user's social network site the data is often presented so that anyone can see a small portion of the user's content which is public content. Other private content with access controlled by the user may have one or more levels of privacy or access. Only a list of trusted contacts approved by the user is able to see private content. Facebook, Google+, Linkedin and Myspace are examples of this kind of social network application among many others.

Content on a user's social networking site may be restricted to data typed into fields or from pull down menus. Alternatively, or in addition, the content may be completely free form and unrestricted. Data may include name, location, contact information, employer, work history, position, photos, audio, video, personal likes and dislikes, relationship status, residence, current location, schools attended, degrees attained, degrees of separation, pictures and an endless array of other categories and information that can be cataloged by the social networking application.

Creating an approved “friend” or trusted contact list for the user generally involves some form of handshake or confirmation by users. A first social network user requests to establish a friend, business or other defined relationship with a second social network user. The request indicates there is an existing relationship or a desire for a relationship with the second user. The second social network user then accepts or rejects the friend connection request. On accepting the request the first and second user are added to each others trusted contact list.

In many applications on being added to the contact list, both first user and second user will have access to some or all of the other user's private information and/or access to more informal communication. Some users pride themselves on their vast number of connections and may not remember all the contacts on their list. A user may have several contact lists for different social network applications or levels of connection. The separate lists may or may not overlap.

In daily use of the internet the user may open a web page in a browser. Web page content is then displayed that may include text, pictures, icons, links and animations. Content separate from any social network site may include information on an individual. For instance a profile of a volunteer with a social service agency may include their name, the town they live in and where they went to school. It may be possible to correlate information in the article to personal data in social network sites to determine that the subject of the profile is in the reader's list of trusted contacts and that the reader has a relationship with the person in the article. The user may not recognize the person in the article and the user may value knowing that the subject is on their contact list.

It would be advantageous to have a tool that would search articles displayed on a browser, compare the content to entries for individuals on social networking sites and on finding a correlation between the article content and the social network personal data of someone on the reader's contact list, the tool would provide an indication of the existing relationship.

For clarity, the term “Link Application” will be used here for this function. The application may apply to more than individuals. It may be used with data related to companies or more general social networking applications like family discussion boards or discussion groups for a common interest.

To illustrate the link application, a first user “Steve” has been searching for a job in finance. Steve has a social network account with a list of contacts and friends he has made over the years and established as trusted contacts in his social network application. In Steve's social network contact list is James Smith who attended high school with Steve. The content of James Smith's social network may include his name, location and position or personal data categories.

Steve is reading an article accessed through a web site with URL “http:\\financex.com.” The article states that James Smith of Brainian Industries is expanding and beginning an initial stock offering. Steve does not realized that the James Smith in the article was the one who attended the same high school and with whom he shares a social network relationship.

On accessing browser content, the link application may extract name, location, company and position information from the article and create a content text string table. Separately the link application may catalog all the personal data for the user's trusted contacts to a personal data string table. The link application may then compare or correlate the personal data table entries to the content table entries and rank the correlation.

The application tool on finding a correlation between the content table and personal data table may provide an indication to Steve that there is a correlation and that Steve may know James Smith. The indication may be that James Smith's name is highlighted in the displayed content indicating Steve can access James Smith's social network content. Rolling the cursor over James Smith's highlighted name may result in a bubble or pop-up window that automatically displays correlation information.

There are many factors involved in predicting if a level of data correlation actually predicts the person is in the user's contact list. These factors may include how common the subject's name is, the likelihood that query information is actually correlated to the contact person, the last update date for the source of social network contact information and many others. Highlighting the most important correlation words in the content may allow the user to assess the accuracy of the correlation.

Certain functions described here will be overly simplified for purpose of illustrating embodiments. Many of the functions that may be required such as pattern matching, identity resolution, entity resolution and string matching are widely studied, often complex in their implementation and are beyond the scope of this disclosure. They are well understood by those skilled in the art and selection of an algorithm may be based on the hardware and content used in the specific application and still fall within the scope of this disclosure.

The application may also be configured to run on any of the machines described here such as a content server, the reader's computer, a smart phone or any other machine connected to a network. For the purposes of illustration it may be described here as running in a specific machine, but that should not be considered a limitation.

### BRIEF DESCRIPTION OF DRAWINGS

FIG. 1 is a depiction of a computer, an application and tables associated with a social network personal data and server accessed content.

FIG. 2 is a depiction of a computer, an application and tables associated with a social network personal data and server accessed content.

FIG. 3 illustrates the parsing of content and entries to lists of text strings by a link application.

FIG. 4 is an example of correlation and relevance ranking by a link application.

FIG. 5 is a depiction of a link application using second tier trusted contacts.

FIG. 6A is an example of a user alert in a user interface for trusted contacts.

FIG. 6B is an example of a user alert in a user interface for trusted contacts.

FIG. 7 is a flow chart of a method of operating a link application.

FIG. 8 is a flow chart of of a method of providing and operating a link application.

### DESCRIPTION

Social networks have proliferated in recent years and allow people to share information in new ways and maintain relationships that may have been lost before social networking. Examples of social networking applications include Google+, Linkedin and Facebook. They generally provide for an individual to register using a login, password and some identifying name to create an account with an associated internet space or site. The individual can then customize their accessible space or site with as much personal information as they choose.

Individuals registered with a social networking site may enter data such as job, position and schools attended. A user typically maintains a list of trusted contacts or friends that are also users of the social network and have their own individual sites with personal data entered and cataloged. As a trusted contact a user gains access to some or all of the friend's personal entries.

When a user or reader requests and accesses content from a server, such as a text article on a subject of interest, the link application may find references in the article to contacts listed in the reader's social network application and highlight the relevant information.

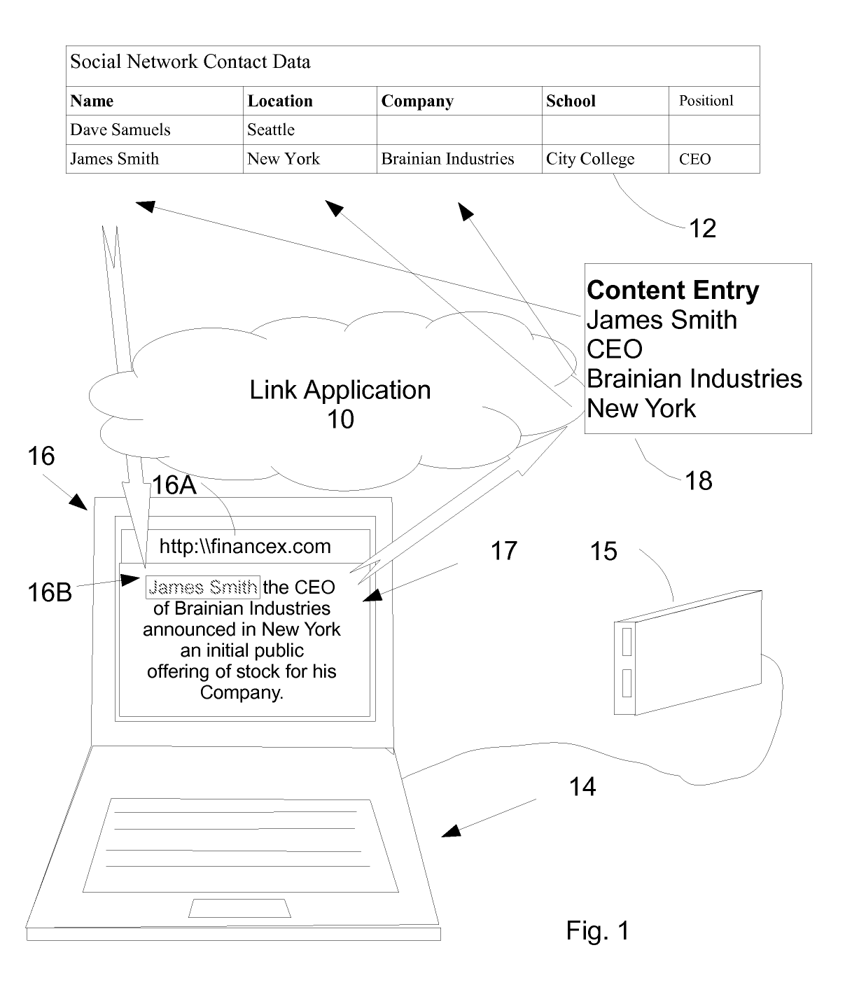

FIG. 1 shows a general representation of the application in use. FIG. 1 shows a link application 10 as a cloud mediating entries from a social network personal data table 12 and a computer 14. Content server 15 has accessed the requested content and computer 14 is displaying content 16 in a browser or user interface 17. Social network personal data table 12 is shown with a list of people (contacts) that have agreed to be connected to the user with additional entries for residence, a company that may employ them or that they are associated with and a school that the person may have attended or are associated with and their professional position.

Content 16 is shown as including a URL 16A that may reference a source location and/or content name such as content server 15 on which the content resides. Content 16 is shown displaying a trusted contact notification 16B as James Smith. Social network personal data related to James Smith has been extracted by link application 10 to content table 18 with the name, a company, a position and a location. Content entry 18 is shown as correlating or being similar to entries in personal data table 12 of a trusted contact in the user's social network, resulting in link application 10 modifying the source text of content 16 to provide a prominent change in text presentation such as highlighting shown here as a box around the text “James Smith”.

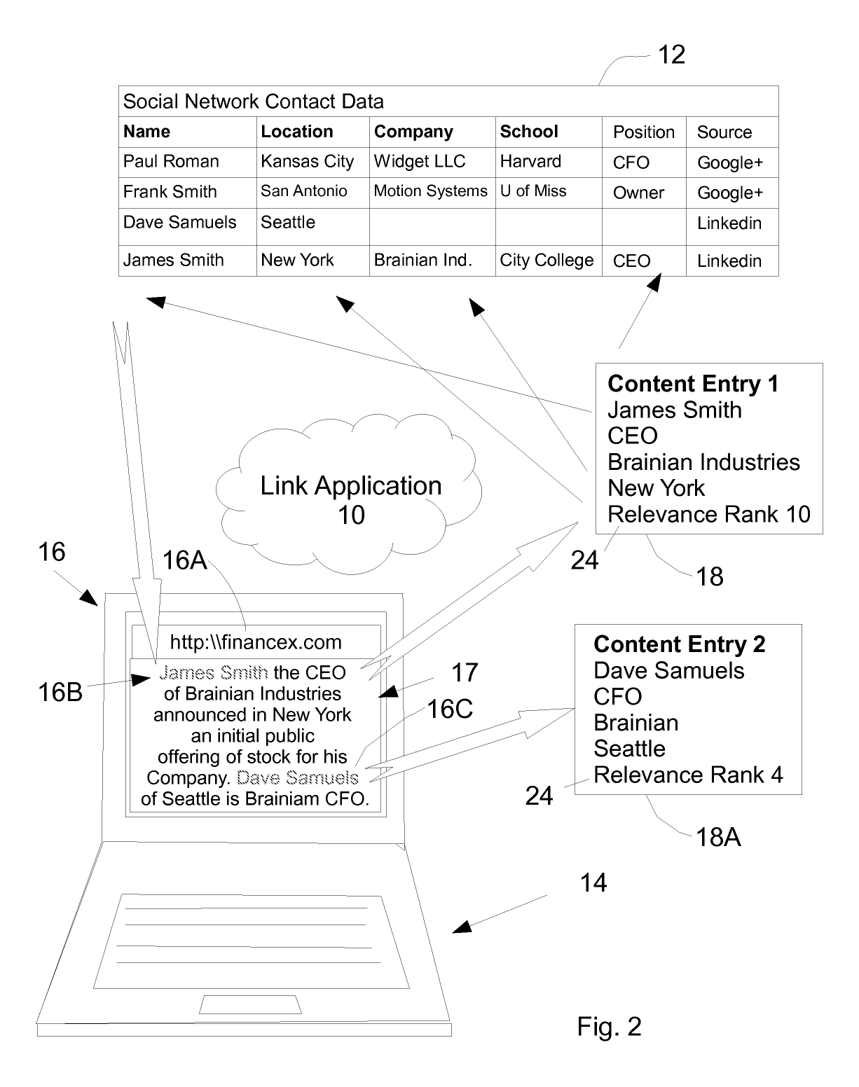

FIG. 2 shows an implementation of the link application 10 similar to FIG. 1. FIG. 2 again includes a laptop 14 accessing a URL 16A shown here as “http:\\financex.com” to display content 16 in a browser window or user interface 17. Link application 10 has extracted content entry 18 for James Smith and for a second reference 16C to Dave Samuels with a content entry 18A.

Link application 10 may concatenate data from more than one social network application. For example the user may register at both Google+ and Linkedin. The two social networks may have different personal data categories and different lists of trusted contact. Here Paul Roman and Frank Smith as shown in personal data table 12 are on the trusted contact lists for the user's Google+ account. Dave Samuels and John Smith are on the trusted contact lists for the user's social network account. Also all of the entry data for different categories has not been supplied at their personal sites by the trusted contacts leaving some entries blank.

Link application 10 identifies text in the browser 17 that corresponds to the categories of personal data table 12. Content entry 18 is shown with the entries “James Smith”, “Brainian Industries”, “New York” and “CEO.” Four of the five categories of personal data from personal data table 12 entries for James Smith correlate to the data in content entry 18. Link application 10 may provide a relevance rank 24. Here the correlation of four entries results in a relevance rank of 9. Application tool 10 on making that correlation, or at a certain threshold level of relevance rank may generate an indication for the user that James Smith may be a trusted contact in the user's contact network.

Link application 10 generates content entry 18A for text related to Dave Samuels. Content entry 18A includes “Dave Samuels”, “CFO”, “Brainian” and “Seattle.” These entries correlate with only two entries in personal data table 12. This produces a relevance rank of 4. Link application 10 may provide different content alerts based on the relevance rank of the correlation. For example highlighted text may be a different color depending on the relevance rank.

Link application 10 may determine what text in content 16 is a name and what text may be associated with that name. Link application 10 may have lookup tables for common names, common cities, common job titles to determine most relevant text. Link application 10 may determine that text proximate to text identified as a person's name may be more likely to be relevant. Link application 10 may extract and group all of the text determined as relevant to a proximate name and create content entry 18 and/or 18A. Link application 10 may include a source key for each extracted text string that maps the string to it's source in content 16. Alternatively, link application 10 may find all locations of a text string in content 16 using a text search of all occurrences.

Link application 10 may be implemented in any number of ways including using C++, Visual Basic, Java or any of several other languages. Link application 10 may reside in memory of user's computer 14 and operate on content 16 before it's downloaded. Alternatively, link application 10 may reside on content server 15 and link application 10 may upload social network personal data to server 15 from either the user's computer or a social network server.

In it's simplest form correlation of tables 20 and 22 includes taking the first entry in table 20 and compares it to each entry of table 22. A count of the number of matches is tallied for each content text string entry. This is repeated for each entry in table 20 and a final score tallied. This is an example of string matching. More sophisticated algorithms would be used for a link application that include hash tables, stemming, synonyms or other advanced tools to optimize speed of searching. These are beyond the scope of this disclosure but are widely studied and well understood by those skilled in the art. Selection of an algorithm may be based on the specific application, the hardware used and the type of content.

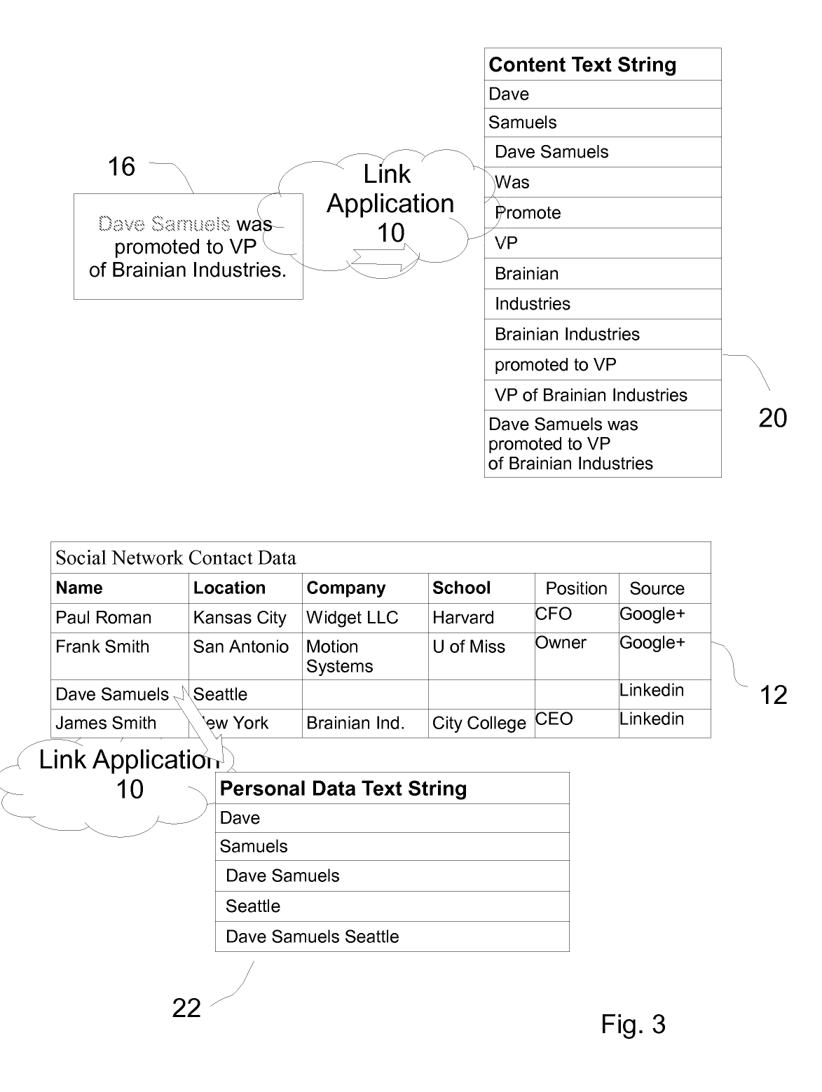

FIG. 3 is a diagram illustrating parsing by link application 10. The portion of content referring to Dave Samuels is shown again as content 16. Content text string table or content table 20 includes words and word sequences from the text of content portion 16. Link application 10 has parsed the phrase to separate the words into likely matches.

Social network contact data sourced from social network accounts is shown in personal data table 12. The two personal data entries for Dave Samuels have been parsed into personal data text string table or personal data table 22. From the two entries five text strings have been parsed and entered. Text strings may include associated metadata and keys with additional information such as the source location in content 16 for specific words and data types. For personal data table 22 the name field may act as a key for each entry to point to the line in a table or position in a database or social network site the personal data entry was sourced from. Alternatively, the name field and all other personal data may have a key or associated metadata of a hyperlink to a social network site.

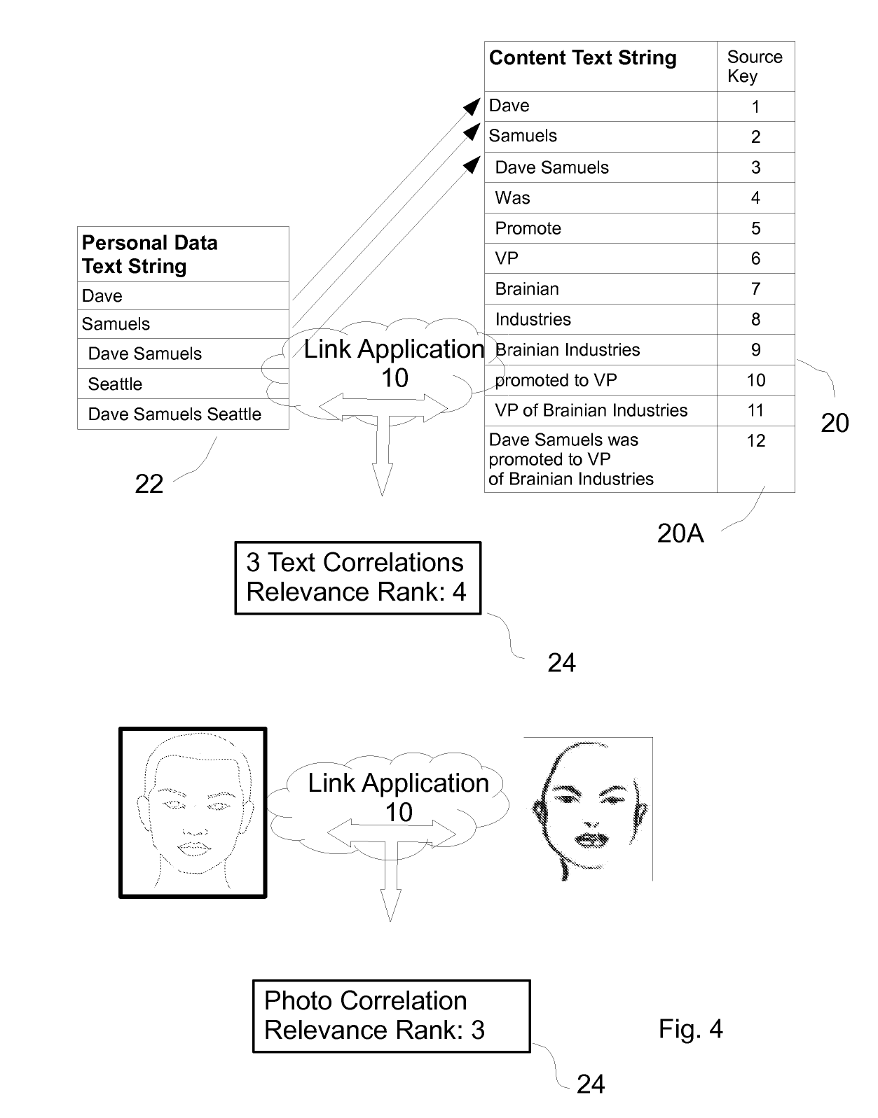

FIG. 4 is a diagram illustrating the correlation and relevance ranking function. Here personal data text string table 22 is correlated to entry text string of FIG. 3. The three strings of “Dave”, “Samuels”, and Dave Samuels” of content text string table 20 all correlate to entries in personal data text string table 22. The three correlations again result in a relevance rank of 4. Content table 20 is shown with a source key column 20A. The source key may indicate or map a source position in content 16.

Link application 10 may also correlate other entries from content 16 and social network personal data table 12 such as pictures. Link application 10 may include functionality for facial recognition. A picture of an individual may also be part of content 16. Here the correlation between two pictures provides a relevance rank of 3.

Correlation and relevance ranking may be governed by a set of ranking rules. Correlation of a last name may have a higher correlation value than correlation of a residence. Correlation of a city may have a lower correlation value and a lower contribution to the ranking value. Further, identifying words and text proximate to a name in content 16 may have another set of rules and a different measure of weight in connecting for example a city name to a person's name in content 16. Indicating to the user that a name in content 16 is likely a trusted contact may require a relevance rank score above a critical threshold level. Different rank ranges may generate different indicators to the user. A relevance rank of 90-100% of a maximum correlation may generated flashing text in content 16. A relevance rank of 80-90% may generate a different color of text without flashing.

The user may be able to adjust parameters associated with correlation functions by link application 10. The user may be able to create or use specific lookup tables. The user may be able to adjust correlation and ranking rules or to adjust threshold levels to their personal preference. Link application 10 may include a user interface or page that provides access to all user accessible variables where variable levels can be changed.

These are examples for the purpose of illustrating core functions. There are different frameworks that can be used to implement these functions. In an alternate configuration link application 10 may actively search for internet content related to a user's trusted contacts. For example, link application 10 may be provided with a list of content sites such as the NYTimes.com or WashingtonPost.com. Periodically, link application 10 may access these sites and search for content that correlates with personal data of trusted contacts. On finding relevant content a portion of that content may be reported back to the user. The portion of the content could be a headline or might be an extracted section of text related to the trusted contact or both.

In another alternate configuration link application 10 may reside on a content server 15 such as NYTimes.com. A user may log into the server where the content 16 and link application 10 are stored. The user may provide server 15 access to their social network accounts when setting up a user account on the server. Server 15 and link application 10 may then download personal data of trusted contacts and operate using the data on requested content.

In another alternate configuration link application 10 may incorporate crowd sourcing techniques when identifying someone listed in an article. Trusted contacts with access to content 16 may provide additional data or correlation. Link application 10 may provide an initial suggestion that a reference in content 16 may be the person in a specific social network site which could then be confirmed through crowd sourcing techniques. This may be indicated by a characteristic highlighting of text.

Trusted contacts may get access to the content with initial correlation assessments and they may have the opportunity to confirm or disprove that the reference in content 16 is the person in the suggested social network site. A list of initial correlations from content 16 may be distributed to trusted contacts as a request for review of accuracy. Confirmed correlations may have a unique identifier to show it has been confirmed. This would allow subsequent readers to have more confidence that the highlighted person is actually a trusted contact.

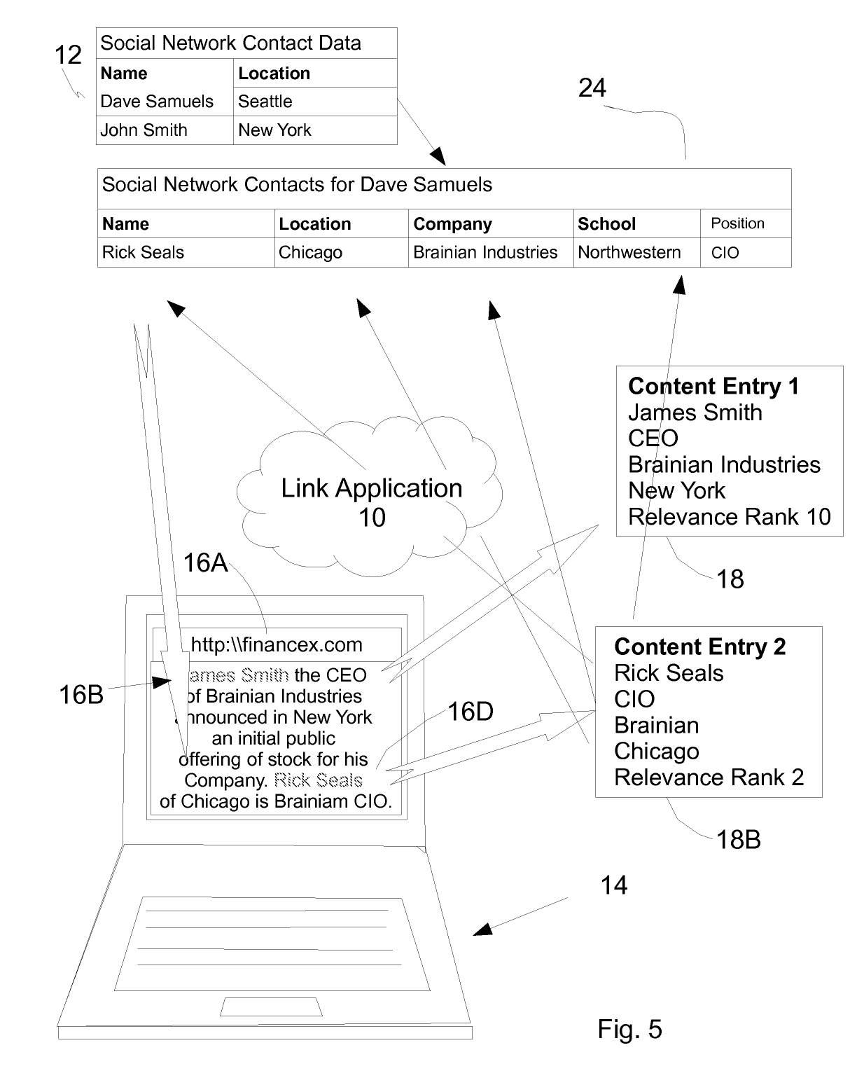

Link application 10 may further utilize information from social networks relating to contacts of contacts in the user's approved list of contacts. These contacts may be termed second tier contacts. FIG. 5 is a diagram of link application 10 using second tier contacts. Content 16 includes a reference 16D to Rick Seals, CIO for Brainian Industries of Chicago. Link application 10 generates content entry 18B including text strings from content 16. Second tier contacts database 24 lists the contacts of Dave Samuels who is in the user's first tier contacts. Rick Seals is in Dave Samuels trusted contact list 24 and is therefore a second tier contact for the user. Link application 10 may indicate to the user that Rick Seals is likely a second tier contact. Link application 10 may use another layer of trusted contacts as a third tier trusted contact in a similar manner.

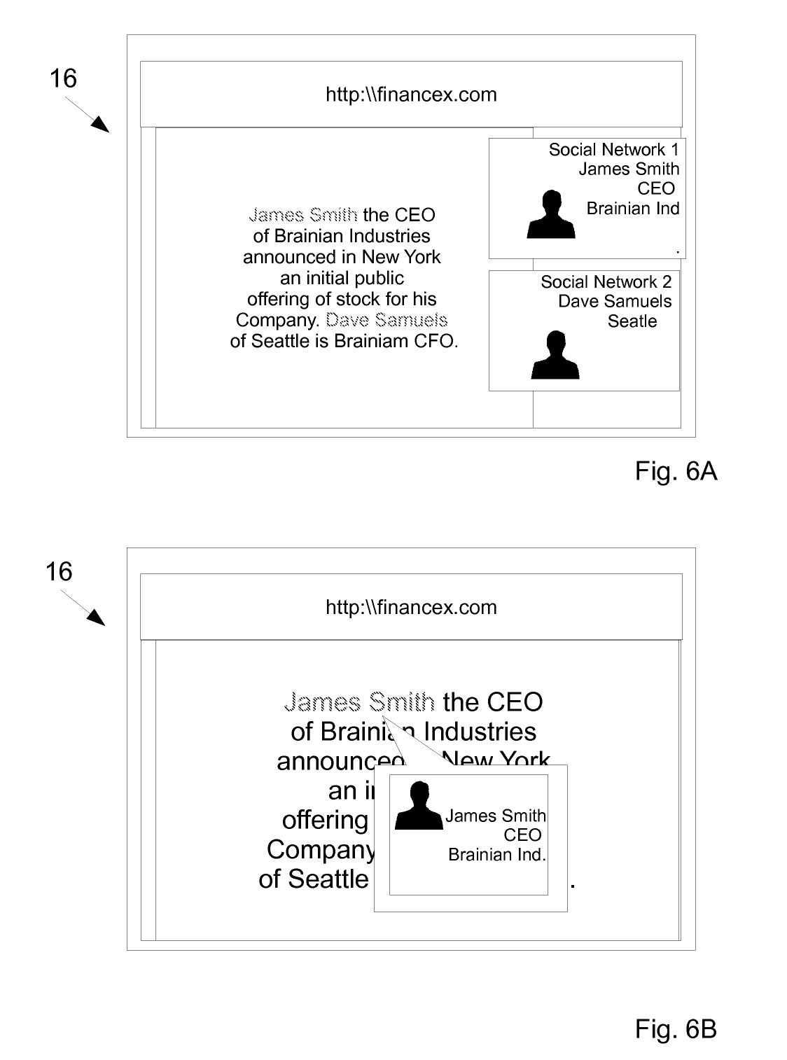

Link application 10 on determining correlation of a name in content 16 to a trusted contact may use a visual or aural indication to communicate with the user. In FIG. 6A link application 10 has identified two likely trusted contacts. Two windows corresponding to social networking sites related to James Smith and Dave Samuels are displayed on the right side of the display. In FIG. 6B a pop-up window with a pointer appears with data related to the social network site for James Smith. In other alternative configurations the display of text may be modified as shown in browser 17 of FIG. 1 with text highlighting. Bottom bars may be used with scrolling text or an aural signal may be used to alert the user. Windows or pop-ups may include links to the social network sites. Modifying the source text may include converting it to a hypertext link so that clicking the text or the name of the person in the text opens a window for the social network site of the trusted contact.

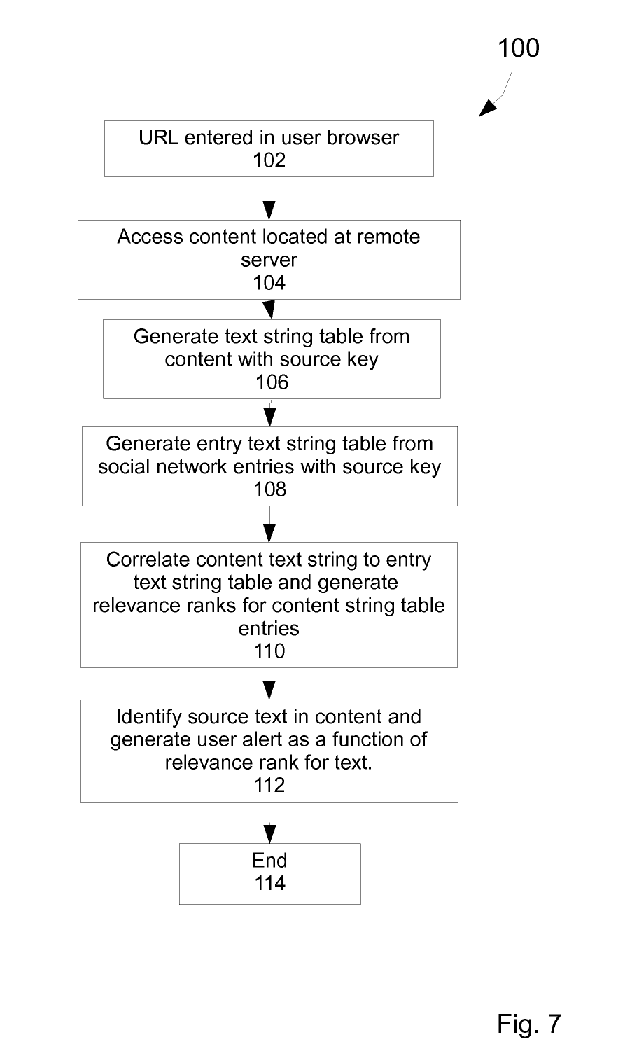

FIG. 7 is a flow chart 100 of one possible algorithm for the steps implemented by link application 10. At 102 a URL is entered at the user's browser and sent to the content server. At 104 the link application program receives the content 16 from the content server 15. At 106 link application 10 extracts text from the accessed content and creates content text string table 20. At step 108 one or more social networks are accessed and the personal data test string table 22 is created. At step 110 the test string and personal data text string tables are correlated and relevance ranks 24 are determined for content text string entries. At step 112 source text in the content is located and a user alert is generated as a function of relevance rank. At 114 the process ends.

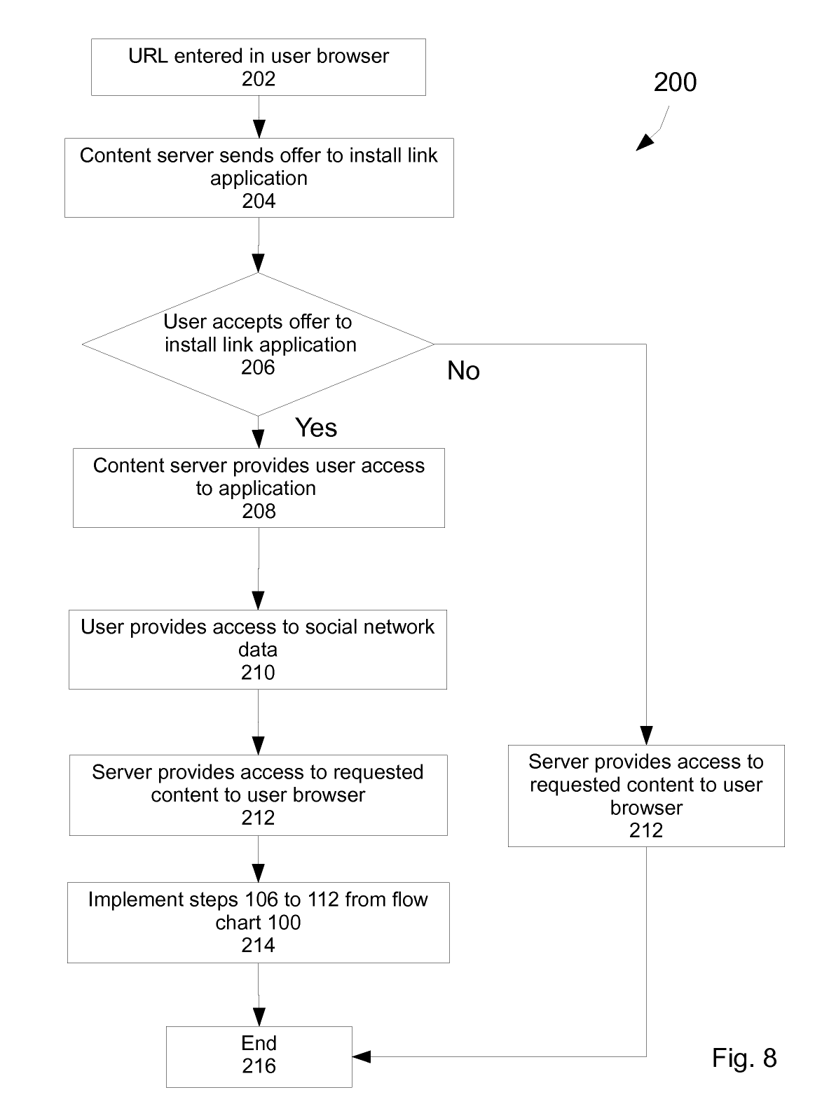

FIG. 8 is a distribution and operating flow chart 200 for a link application 10. In step 202 the user enters a URL request for content at browser 17. At step 204 the content server 15 sends an offer to install link application 10. If the user declines the offer at step 206 the server accesses the requested content and displays it on the user's computer 14 at step 212 and the process ends at step 216. If the user accepts at step 206, then the computer provides access to the application at step 208. At step 210 the user provides access to a social network and runs the application. The server then accesses the requested content for display on user interface 17 at step 212. At step 214 steps 106 to 112 from flow chart 100 are implemented. At step 216 the process ends.

The sequence of steps of process 100 and or 200 may be altered in some cases without affecting the end product. For example content 16 can be accessed before the application is offered or the text string tables can be generated in a different order.

Browser 17 or the web page displayed by browser 17 may include additional information or metadata that is not displayed on the browser. Link application 10 may use this metadata, data from the web page URL 16A or data related to the URL name or other site content including images and contact photos in making correlations to social networking data.

The described system and assemblies are examples and are not to be used as limitations. The table configurations or categories of personal data may be different than those shown. Any suitable configuration or combination of components presented, or equivalents to them that perform a similar function, may also be used.

1) A method for associating internet published content with trusted contacts listed in a social network comprising:
select content to be viewed in a user interface;
access content residing on a server at a user computer;
create a personal data table from personal data including names in a users social network for trusted contacts;
create content table from content text strings including names;
correlate personal data table to content table and rank the correlation of each content table entry;
locate source of each content text entry in content; and
modify display of content entry in content as a function of the correlation rank.

2) The method for associating internet published content with contacts of claim 1 where the content table further includes pictures from content and the personal data table includes pictures of social network trusted contacts.

3) The method for associating internet published content with contacts of claim 1 where at least one text entry in the content table is all the text of the content.

4) The method for associating internet published content with contacts of claim 1 where modifying the display includes displaying an additional window with trusted contact information.

5) The method for associating internet published content with contacts of claim 1 where the personal data table includes personal data including names of second tier trusted contacts.

6) An application for modifying displayed content as a function of correlation to social network personal data comprising:
a user interface to display content;
content including text selected from a server by a user for display on the user interface;
a content table of one or more text strings from the content with content location keys populated by the application;
a personal data table of personal data entries from the user's social network with source keys populated by the application; and
a rank for each content table text string;
where each content text string is ranked by its correlation to the list of personal data entries and the location key for each text string identifies the source of each word in the content and display of the content is modified based on the rank of the text string.

7) The application to modify displayed content of claim 6 where each text string is one or more words.

8) The application to modify displayed content of claim 6 where at least one text string of the content table includes all the text in the content.

9)The application to modify displayed content of claim 6 where the list of text strings includes each word is a text string in the list and sets of sequential words in the content are text strings in the list.

10) The application to modify displayed content of claim 6 where modifying the display of content includes modifying the appearance of text in the content.

11) The application to modify displayed content of claim 6 where the personal data table includes personal data for second tier contacts.

12) A method of providing trusted contact information from a content provider comprising:
sending from the content provider an offer for a software application to be installed on the user's computer in response to a reader requesting content from the content provider;
sending the software to memory in the reader's computer and installing the software in response to receiving a request from the reader for the software application; and
running the software application in response to downloading content from the publisher;
where the software application:
accesses personal data from the user's social network trusted contacts;
creates a table of personal data text strings from the user's social network trusted contacts;
creates a table of one or more content text strings from the downloaded content;
determines a relevance rank of each text string in relation to each social network text string; and
modifies the display of the source text on the user interface based on the relevance rank for that text string.

13) The method of providing trusted contact information from a content provider of claim 12 where the personal data text strings include names of individuals.

14) The method of providing trusted contact information from a content provider of claim 12 where the personal data text strings include names of companies.

15) The method of providing trusted contact information from a content provider of claim 12 where the table of personal data strings includes personal data for second tier trusted contacts.

16) The method of providing trusted contact information from a content provider of claim 12 where the social network text strings include locations.

17) The method of providing trusted contact information from a content provider of claim 12 where the relevance rank is calculated based on a set of rules that weights each category of personal data from the social network.

18) The method of providing trusted contact information from a content provider of claim 12 where the personal data includes a picture and the content table includes a picture taken from content and a relevance rank is calculated for the two pictures.

19) The method of providing trusted contact information from a content provider of claim 10 where modifying the display of the source text includes displaying a social network page of a trusted contact.
